(19) United States
(12) Patent Application Publication
(10) Pub. No.: US 2011/0078797 A1
(43) Pub. Date: Mar. 31, 2011

(54) Endpoint security threat mitigation with virtual machine imaging

(75) Inventors: Brent R. Beachem, Riverton, UT (US); Merrill K. Smith, Riverton, UT (US); Richard B. Rollins, Riverton, UT (US)

(73) Assignee: Novell, Inc.

(21) Appl. No.: 12/220,893

(22) Filed: Jul. 29, 2008

(51) Int. Cl. G06F 21/00

(52) U.S. Cl. 726/25; 726/22

(57) ABSTRACT

Methods and apparatus involve the mitigation of security threats at a computing endpoint, such as a server, including dynamic virtual machine imaging. During use, a threat assessment is undertaken to determine whether a server is compromised by a security threat. If so, a countermeasure to counteract the security threat is developed and installed on a virtual representation of the server. In this manner, the compromised server can be replaced with its virtual representation, but while always maintaining the availability of the endpoint in the computing environment. Other features contemplate configuration of the virtual representation from a cloned image of the compromised server at least as of a time just before the compromise and configuration on separate or same hardware platforms. Testing of the countermeasure to determine success is another feature as is monitoring data flows to identifying compromises, including types or severity. Computer program products and systems are also taught.

### FIELD OF THE INVENTION

Generally, the present invention relates to computing devices and computing environments under security threats. Particularly, although not exclusively, it relates to a compromised computing endpoint, such as a server, having threat mitigation by way of dynamic virtual machine imaging, but while always or nearly always maintaining the availability of the endpoint. Other features contemplate configuration of virtual representations, configuration on hardware platforms, planning and testing of countermeasures that counteract the security threat, monitoring for threats, and computer program products and systems, to name a few.

### BACKGROUND OF THE INVENTION

As is well known, threats to computing environments take many forms, such as viruses, malware, spyware, Trojan horses, etc. In turn, many products exist to counteract the threats and include, for example, anti-virus (AV) programs, threat monitoring, threat cleaning/removal, intrusion protection systems/intrusion detection systems (IPS/IDS), network quarantining, AV patching, etc. But in most technologies, searching for threats and counteracting them consists of some form of signature-based or heuristic monitoring. While effective in many instances, signature-based monitoring relies on making matches to signatures of previously discovered threats, while heuristics require some form of suspicious or curios behavior in order to conduct follow-on threat investigations. To the extent a threat is a “zero-day” threat, no signature exists for match-making and heuristic approaches avoid follow-on investigating for want of recognizing suspicious or curios behavior. Thus, modern threat mitigation techniques are proving insufficient on zero-day.

Also, it presently exists that the discoverer of the zero-day threat often approaches the vendor of the infected product/application or a third party AV provider for assistance in patching/fixing the discovered problem. While a necessary step in the overall war to combat threats and make products/applications more reliable, patches to zero-day threats can regularly take days, weeks, or more to diagnose and solve, which makes the product/application unavailable for extended periods of time. Alternatively, or in addition to, skilled system administrators often undertake repair, deletion, restoration to an earlier time, and/or quarantining of the infected product/application. Deleting and quarantining, however, are problematic for such does nothing to make the product/application available for use. Repair, while typically shorter than awaiting a patch from the vendor, still keeps the product/application unavailable for a time, and often leaves behind artifacts that are entirely unacceptable in computing situations involving sensitivity, such as financial transactions, secret or confidential information, homeland security, etc. Restoration to a time earlier than when the threat or attack became active, only works effectively to the extent the threat activity occurred contemporaneously with the infection. In that many threats can lie dormant for days, weeks, months, or years, reverting to an earlier time might not be early enough to combat the actual infection date. Also, the actual time of infection is often difficult to know.

Accordingly, a need exists in the art of threat mitigation for a more reliable system. The need further contemplates a system that can effectively combat zero-day threats, while also maintaining availability of computing devices that are currently under attack. Naturally, any improvements along such lines should further contemplate good engineering practices, such as ease of implementation, unobtrusiveness, stability, etc.

### SUMMARY OF THE INVENTION

The foregoing and other problems become solved by applying the principles and teachings associated with the hereinafter-described mitigation of security threats at a computing endpoint, such as a server, including dynamic virtual machine imaging. At a high level, methods and apparatus first identify whether a computing server is compromised by a security threat and, if so, the threat is counteracted with a countermeasure installed on a virtual representation of the compromised server. In this manner, compromised devices can be quickly replaced, but while always maintaining the availability of the server/endpoint in the computing environment.

In various embodiments, a virtual representation is made from a cloned image of the compromised device at least as of a time just before the compromised device became infected by the security threat. Also, the virtual representation may be configured on a separate or same hardware platform as the compromised device. Threat assessment occurs by monitoring data flows relative to the computing device and, upon actual identification, threat type or severity is also attempted to be characterized. In the event the type or severity meets a predetermined threshold, a virtual representation of the compromised device is stood-up to operationally replace the original device, including installation of an active countermeasure. Before standing up, testing of the countermeasure to determine success in counteracting the security threat may be also undertaken.

As a result, it should be appreciated that restoration of a compromised device by way of a virtual representation has advantage not only in the form of maintaining computing availability, but also in the form of avoiding requiring restoration of a full operating system state environment. Namely, a virtual representation is often much smaller than a full operating system state environment and restoration of only an application environment state, for example, increases the speed of the restoration and decreases the need for computing and human resources. Further, virtual restoration need not requiring re-imaging of an entire boot partition and physical distribution partition of a physical server. Therefore, the amount of time, as well as computing and human resources, required to restore an application environment is reduced.

In a computing system embodiment, the invention may be practiced with: a computing server at the endpoint having been identified as compromised by a security threat; and a virtual server to replace the compromised server while always maintaining the availability of the endpoint, the virtual server having installed thereon a countermeasure to counteract the security threat and otherwise being a cloned image of the computing server at least as of a time just before the computing server became compromised by the security threat. Executable instructions loaded on one or more of the servers, or on an entirely different computing device, for undertaking the foregoing methodologies are also contemplated as are computer program products available as a download or on a computer readable medium. The computer program products are also available for installation on a network appliance or individual computing devices.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a combined diagrammatic view and flow chart in accordance with the present invention of a representative computing environment for mitigating security threats with virtual machine imaging; and

FIG. 2 is a flow chart in accordance with the present invention for features of mitigating security threats with virtual machine imaging.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for mitigating security threats at a computing endpoint, such as a server, including dynamic virtual machine imaging are hereinafter described.

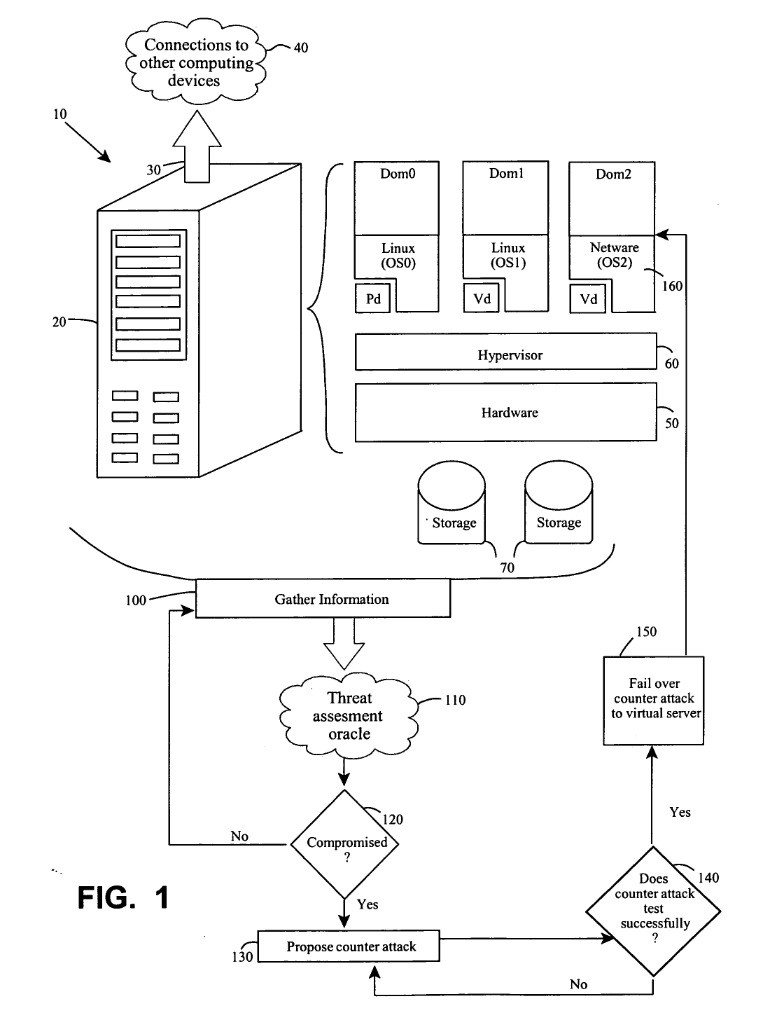

With reference to FIG. 1, a representative computing system environment 10 includes a computing device 20 in the form of a server. It can be of a traditional type, such as a grid or blade server, and can fulfill any future-defined or traditional role, such as a web server, email server, database server, file server, etc. In network, it is arranged to communicate 30 with one or more other computing devices or networks, and skilled artisans readily understand the configuration. For example, the server may use wired, wireless or combined connections, to other devices/networks and may be direct or indirect connections. If direct, they typify connections within physical or network proximity (e.g., intranet). If indirect, they typify connections such as those found with the internet, satellites, radio transmissions, or the like, and are given nebulously as element 40. In this regard, other contemplated items include other servers, routers, peer devices, modems, Tx lines, satellites, microwave relays or the like. The connections may also be local area networks (LAN), wide area networks (WAN), metro area networks (MAN), etc., that are presented by way of example and not limitation. The topology is also any of a variety, such as ring, star, bridged, cascaded, meshed, or other known or hereinafter invented arrangement.

In more detail, the physical server can be arranged in a variety of ways, including virtual representations such as according to the Zen architecture for Novell, Inc., (the assignee of the invention). Namely, the architecture can include a multiplicity of domains (DOM0, DOM1, DOM2) and a variety of operating systems (OS0, OS1, OS2) (e.g., Linux, Linux and Netware). In turn, each can be configured on a common hardware platform 50, with an intervening hypervisor 60. Representatively, the hardware embodies physical IO and platform devices, such as memory, a CPU, disk, USB, etc., while the hypervisor, which is the virtual interface to the hardware (and virtualizes the hardware), manages conflicts, for example, caused by operating system access to privileged machine instructions. The hypervisor can also be type 1 (native) or type 2 (hosted), and skilled artisans understand the terminology. The physical distribution component, or pDISTRO, (“Pd” in FIG. 1) is functionality typically configured specifically for the hardware and used to deploy physical machine specific hypervisors with drivers, agents, sound cards, etc., needed by specific hardware vendors, and it may also include a file system or a directory service configured specifically for the hardware or a management function and a management interface. The virtual distribution components, or vDISTRO (“Vd” in FIG. 1), which may exist collectively on or in the pDISTRO, is used to deploy the virtual machines on the physical server and can move application stacks between them in real-time. (Naturally, the virtual distribution components may be customized and are typically optimized to support a dedicated workload. In this regard, each individual virtual machine may be configured with a different operating system. Also, the functionality of an individual virtual machine may be an application, shared service of the enterprise, or other known or later invented useful computing application(s). Of course, it is well known how a virtual machine can be configured and associated with virtual disks and content in the virtual disk and physical disks and content in the physical disk.). In domain, DOMO is the management domain for Zen guests and dynamically undertakes control of computing resources, such as memory, CPU, etc., provides interface to the physical server, and provides various administration tools. Domains DOM1 or DOM2 are those that host the application workloads per each virtual machine, including virtual device drivers which connect to the physical drivers in DOMO by the hypervisor or physical device drivers in a direct fashion, and can be stored as a file image on remote or local storage devices 70. Of course, other arrangements are possible.

With the representative server configuration as backdrop, methods and apparatus for mitigating security threats at a computing endpoint, including dynamic virtual machine imaging, begins first by gathering information 100 about the environment. In this regard, it is contemplated that data flows in/out of the environment 10 will be monitored for threats. Representatively, this may include techniques known in the prior art, such as those described as signature-based or heuristic approaches, or other known or later discovered techniques. In either, the monitoring examines the data flow for items such as file system transactions, network access, registry entries, traffic patterns, etc.

Thereafter, this gathered information is feed to a threat assessment oracle 110 to determine, ultimately, whether the computing device is compromised by the threat, step 120. In a traditional fashion, the oracle may compare signatures to already discovered threats, or examine (heuristically) behavior in the gathered information to determine whether a threat exists. If no threat exists, no compromise has occurred and the process of threat mitigation repeats according to gathering information 100 and examining it in the oracle 110 until such time as a compromise is found at step 120.

On the other hand, upon a compromise being determined at step 120, a countermeasure or counterattack to counteract the threat is proposed, step 130. For instance, if a particular known virus is discovered that infects applications of the server, a proposal to counteract the virus may consist of finding a patch for the application. Upon testing the proposed counterattack at step 140, if such is unsuccessful, the process repeats to finding another counterattack until eventually one is found that proves successful.

On the other hand, if the testing confirms success of the counterattack at step 140, it is “failed-over” onto a virtual representation of the compromised device, step 150. Namely, a virtual server 160 is loaded with a fully-tested countermeasure to counteract the virus/attack, but also the virtual server is a “cloned image” of the compromised server (e.g., a cloning of the base image of the compromised device occurring prior to the compromise), which mirrors the functionality, applications, file system, data, etc., of the compromised server, and is used thereafter in place of the compromised device. In this manner, compromised devices can be quickly replaced, but while always or nearly always maintaining the availability of the server/endpoint in the computing environment. Heretofore, this has been unavailable with conventional devices and techniques. (Of course, the virtual representation of the compromised device could occur on a same hardware platform as the compromised device, but there is no reason why a wholly separate virtual machine on separate hardware could not be used.)

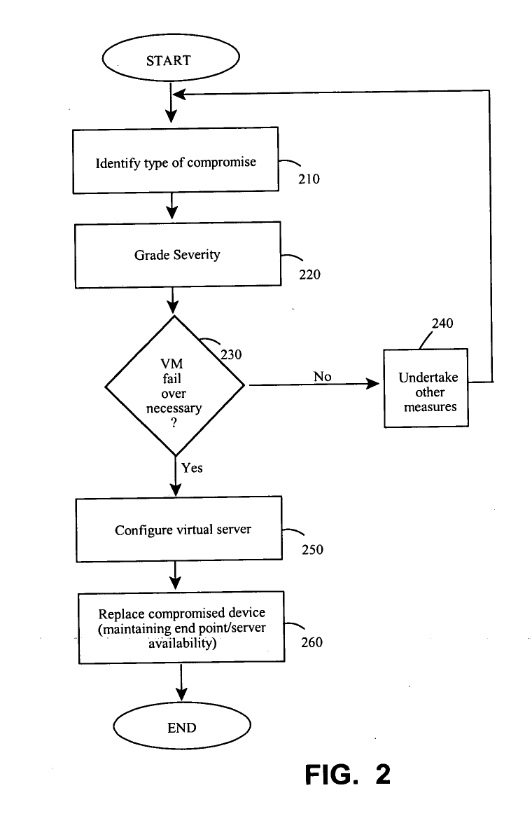

With reference to FIG. 2, nuances of various embodiments first contemplate identifying a type 210 and severity 220 of the compromise, to the extent such can be made. For example, the compromise of the server may be identified by the oracle as one or more of a hardware failure, a software failure, a combined failure, etc. In turn, the failure may be graded or identified according to severity, such as whether the failure is a simple failure, a complex failure, a catastrophic failure, etc. Also, several different categories of failures may be sub-identified, such as whether a hardware failure is a memory failure, a CPU failure, etc., or whether a software failure is a failure of a particular application and where on the server such occurred.

Then, at step 230, it is determined whether a fail over to a virtual machine is altogether necessary or whether the appropriate resolution is that of some other measure, such as rebooting the computing device or reinstalling a software program. In the event virtual fail over is unnecessary, the appropriate resolution is shown by undertaking other measures at step 240 and ending the process until such time as another compromise is detected, and the process repeats. On the other hand, if virtual fail over is indeed determined to be the appropriate course of action, such as determining that the type and or severity of the threat exceeded some predetermined threshold or criteria, actual configuration of the virtual server occurs at step 250.

The foregoing can also be contemplated on a spectrum, of sorts, such that the step of determining whether fail over is even necessary first begins with very narrow remediation attempts at step 240 and then, iteratively, going ever wider or broader for more drastic solutions. For example, if a virus, Trojan horse, etc. was identified as the type of compromise infecting an endpoint/server at step 210, and the severity at step 220 was such that there was no means of quarantining any particular file, the “other measures” at step 240 could first begin with downgrading process privileges, changing file system access control, changing general application control (execution or network access), etc. and then regrading its severity at step 220. To the extent such attempts did not satisfactorily correct or fix the problem, but still did not rise to the level of needing to fail over to a virtual machine at step 250, the next and future rounds of “other measures” at step 240 could consist of changing a firewall, then disabling network adapters, etc., with a last resort of shutting down the computing device. In comparison to current approaches for Trojan horses with no zero-day remedy, computing devices are regularly immediately shut down, which is an instantaneously drastic remedy, with no mechanism for undertaking other, less severe remedies or for eventually failing over to a virtual machine, as done here at step 250.

Returning to the present embodiments of the invention(s), configuration at step 250 consists at a high level of loading the appropriate countermeasure on the server and getting installed the appropriate virtual environment (vDISTRO) and its attendant applications, data, files, etc. In so doing, however, it may be further necessary to contemplate items such as determining storage requirements, processing requirements, processing architectures, operating systems, performance settings per operating system, such as LINUX, as opposed to NETWARE, WINDOWS, UNIX, etc. Naturally, this and other determinations can occur via humans, machines, executable code, or in any fashion.

Finally, at step 260, the compromised device is operationally replaced by its virtual representation (at least as of a time before infection of the compromised device occurred), including the countermeasure to combat the detected threat. As before, this minimizes or eliminates down time of the computing endpoint and is faster than conventional approaches to the problem of threats, especially those of the zero-day type.

Appreciating that enterprises can implement some or all of the foregoing procedures with humans as well as computing devices, skilled artisans will understand that a threat mitigation of a compromised device may be managed by people, such as system administrators, as well as executable code, or combinations thereof. In turn, methods and apparatus of the invention further contemplate computer executable instructions, e.g., code or software, as part of computer program products on readable media, e.g., disks for insertion in a drive of computing device, or available as downloads or direct use from an upstream computing device. When described in the context of such computer program products, it is denoted that items thereof, such as modules, routines, programs, objects, components, data structures, etc., perform particular tasks or implement particular abstract data types within various structures of the computing system which cause a certain function or group of function, and such are well known in the art.

Although the foregoing has been described in terms of specific embodiments, one of ordinary skill in the art will recognize that additional embodiments are possible without departing from the teachings of the present invention. This detailed description, therefore, and particularly the specific details of the exemplary embodiments disclosed, is given primarily for clarity of understanding, and no unnecessary limitations are to be implied, for modifications will become evident to those skilled in the art upon reading this disclosure and may be made without departing from the spirit or scope of the invention. Relatively apparent modifications, of course, include combining the various features of one or more figures with the features of one or more of other figures.

1. In a computing system environment, a method of counteracting a security threat, comprising:
identifying whether a computing device of the environment has been compromised by the security threat;
if so, developing a countermeasure to counteract the security threat; and
replacing the computing device having been identified as compromised with a virtual computing device having the countermeasure.

2. The method of claim 1, further including configuring the virtual computing device from an image to mirror the data and functionality of the computing device having been identified as compromised.

3. The method of claim 2, wherein the configuring further includes configuring the virtual computing device on a same hardware platform as the computing device having been identified as compromised.

4. The method of claim 1, further including testing the countermeasure to determine success in counteracting the security threat.

5. The method of claim 1, monitoring data flow relative to the computing device to said identify whether the computing device has been compromised by the security threat.

6. The method of claim 1, further including identifying a type of the security threat.

7. The method of claim 1, further including determining a severity of the security threat

8. The method of claim 1, further including iteratively taking measures to determine whether the replacing the computing device having been identified as compromised with the virtual computing device is necessary.

9. In a computing system environment, a method of counteracting a security threat, comprising:
identifying whether a computing server of the environment has been compromised by the security threat;
developing a countermeasure to counteract the security threat;
configuring a virtual server from an image of the computing server having been identified as compromised, the virtual server having the countermeasure installed; and
operationally replacing the computing server with the virtual server.

10. The method of claim 9, wherein the configuring further includes configuring the virtual computing device on a same hardware platform as the computing server having been identified as compromised.

11. The method of claim 9, further including testing the countermeasure to determine success in counteracting the security threat.

12. The method of claim 9, monitoring data flow relative to the computing device to said identify whether the computing server has been compromised by the security threat.

13. The method of claim 12, supplying the monitored data flow to a threat assessment oracle to said identify whether the computing server has been compromised by the security threat.

14. The method of claim 9, further including identifying a type or severity of the security threat.

15. The method of claim 9, further including maintaining availability of a server endpoint in the computing system environment during said identifying, developing, configuring and replacing.

16. In a computing system environment, a method of counteracting a security threat at a server endpoint in the system, comprising:
identifying whether a computing server of the environment has been compromised by the security threat, including identifying a type and severity of the security threat;
if the type or severity of the security threat meets a predetermined threshold, developing a countermeasure to counteract the security threat;
testing the countermeasure to determine success in counteracting the security threat;
if the testing is successful, configuring a virtual server from an image of the computing server having been identified as compromised, the virtual server having the countermeasure installed and mirroring the functionality and data of the compromised computing server at least as of a time just before the compromised computing server became infected with the security threat; and
operationally replacing the computing server with the virtual server having the countermeasure, including maintaining the availability of the endpoint server in the computing system environment.

17. A computing system having a computing endpoint, comprising:
a computing server at the endpoint having been identified as compromised by a security threat; and
a virtual server to replace the computing server at the endpoint while maintaining an availability of the endpoint, the virtual server having installed thereon a countermeasure to counteract the security threat and otherwise being a cloned image of the computing server at least as of a time just before the computing server became compromised by the security threat.

18. The computing system of claim 17, wherein the computing server and the virtual server exist on a same hardware platform.

19. The computing system of claim 17, wherein the computing server includes executable instructions to monitor data flows between other computing devices to identify when the computing server becomes compromised by the security threat.

20. A computer program product available as a download or on a computer readable medium for loading on a computing device of a computing system environment to counteract a security threat at a server endpoint in the system environment, the computer program product having executable instructions, comprising:
a first component configured to identify whether a computing server at the endpoint has been compromised by the security threat, including identifying a type and severity of the security threat; and
a second component to install on a virtual server a countermeasure to counteract the security threat.

21. The computer program product of claim 20, further including a third component to configure the virtual server from an image of the computing server at least as of a time just before the computing server became infected with the security threat.

22. The computer program product of claim 20, further including a third component to operationally replace at the endpoint the computing server with the virtual server having the countermeasure while always maintaining the availability of the endpoint in the computing system environment.

23. The computer program product of claim 20, wherein the first component further includes configuration to identify a type or severity of the security threat.

24. The computer program product of claim 23, wherein the first component further includes configuration to determine whether the type or severity meets a predetermined threshold so as to determine whether the second component indeed needs to install the countermeasure on the virtual server.

25. The computer program product of claim 20, further including a third component configured to determine success of the countermeasure in counteracting the security threat.
